(19) United States
(12) Patent Application Publication
(10) Pub. No.: US 2006/0143157 A1
(43) Pub. Date: Jun. 29, 2006

(54) Updating organizational information by parsing text files

(75) Inventor: Richard Landsman, Scotts Valley, CA (US)

Correspondence Address: ATTENTION: SARA D. JONES;Workman Nydegger and Seeley, 60 E South Temple, 1000 Eagle Gate Tower, Salt Lake City, UT, 84111, US

(73) Assignee: America Online, Inc.

(21) Appl. No.: 11/078,641

(22) Filed: Mar. 11, 2005

Related U.S. Application Data
(60) Provisional application No. 60/639,914, filed on Dec. 29, 2004.

(51) Int. Cl. G06F 17/30

(52) U.S. Cl. 707/2

(57) ABSTRACT

Systems and methods for updating a user's organizational information. A text application is provided including a parser module for analyzing text documents accessed by a user and creating or updating the user's organizational information depending on whether organizational information exists in the text document. The parser module may further identify the type of organizational information and communicate with an organizational information application to find the correct template for the organizational information. The organizational information is inserted into the selected templates and saved with the user's organizational information.

### CROSS-REFERENCE TO RELATED APPLICATIONS

This application claims benefit from and priority to U.S. Provisional Patent Application Ser. No. 60/639,914, filed Dec. 29, 2004 and entitled “UPDATING ORGANIZATIONAL INFORMATION BY PARSING TEXT FILES,” which application is incorporated herein by reference in its entirety.

### BACKGROUND OF THE INVENTION

1. The Field of the Invention

The present invention provides systems, methods and software configurations for a text application that parses the text of the text document to determine if organizational information is present. If organizational information is present, the present invention updates the user's organizational information.

2. The Relevant Technology

The electronic age has revolutionized the way in which people communicate. In many cases, paper has been replaced with electronic documents. However, people continue to use electronic documents in much the same way that paper documents are used—to send messages to other people, to maintain lists for organizational purposes, to keep journals, and the like. Various text-based software applications have been developed to enable people to continue to use text-based electronic documents for these purposes. For example, email has become a primary means for people to send text-based messages to each other. Instant messaging and text messaging have developed as alternative ways to send text-based messages. Various organizational information software applications have been developed to assist people in organizing personal contact, calendar, journal, and task information.

Even these seemingly different ways of creating and using text-based documents can be related. Users have long sent e-mail or instant messages to others with information relating to organizational information such as contact information, appointments, and the like. In addition, a user may subsequently write themselves an email as a reminder to schedule an appointment, add information to a contacts list entry, etc. Alternatively, the user may create an additional organizational information entry for the new contact, appointment, task, etc. However, the additional time it takes to duplicate the information into the user's organizational information can be time consuming.

In other words, a user cannot accomplish more than one task at a time even though the same information is typically involved. For example, an email that contains an appointment is not automatically entered into the calendaring application. Instead, the user is required to make the entry in addition to sending the email. The user's effort is therefore duplicated.

### BRIEF SUMMARY OF THE INVENTION

The present invention provides a text application that parses the text of a text document to determine if organizational information is present. If organizational information is present, embodiments of the present invention can automatically update the user's organizational information with the appropriate information in the appropriate organizational information category.

Embodiments of the present invention can exemplarily include a parsing module which communicates with an organizational information dictionary to identify and classify organizational information found in a text document. The parsing module can also be combined with a text application that includes a user interface for accessing (e.g., drafting or reading) a text document and one or more delivery mechanisms or actions for handling the text document.

The user interface used to access the text document communicates with action modules that correspond to applications used to initiate a particular action depending on the text document. The action modules and associated applications can perform text messaging, instant messaging, email, maintain organizational information, and store text documents. The applications may also associate with one or more databases which store information to assist in completing the desired action function. The user can select one or more of the actions before, during and/or after accessing the text document. The user can further perform more than one action on a particular text document.

A text application can be accessed in multiple ways. For example, a user could draft a text document, a user could retrieve a text document from the user's organizational information (e.g., the user's inbox or calendar), or a user could upload a text document. Once the text document is accessed or created, the user can select a delivery mechanism or action for the text document. After the user accesses the text document (and, optionally, selects a delivery mechanism), the parser module communicates with an organizational information dictionary to identify the existence and type of organizational information. The parser module communicates with the organizational information module and application to select the appropriate organizational information template. The parser module can further insert the appropriate organizational information into the corresponding fields of the organizational information template and create a new organizational information entry. Alternatively, the parser module can compare an existing organizational information entry and request the user to confirm updating of the existing entry. The parser module may request additional information from the user. The user's organizational information is then updated with the new or amended organizational information.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows an exemplary process according to embodiment of the present invention for updating organizational information from a text document;

FIGS. 2A through 2C show an exemplary user interface through various steps of the parsing feature according to embodiments of the present invention;

FIG. 3 shows a diagram illustrating an exemplary system and software configuration according to embodiments of the present invention; and

FIG. 4 shows a diagram illustrating an exemplary flow diagram for updating organizational information from a text document.

### DETAILED DESCRIPTION OF EXEMPLARY EMBODIMENTS

The present invention relates to systems, methods and software configurations for updating organizational information. This is achieved, for example, by parsing a text document and determining whether the text document contains organizational information. If organizational information is detected in the text document, the organizational information is inserted into an appropriate organizational information entry or updated as needed. In one embodiment, this parsing feature can be used in combination with a multi-purpose text application which can perform multiple delivery mechanisms or actions on the text document accessed by the user. Advantageously, a user does not have to commit to a particular delivery mechanism when the text document is initially created.

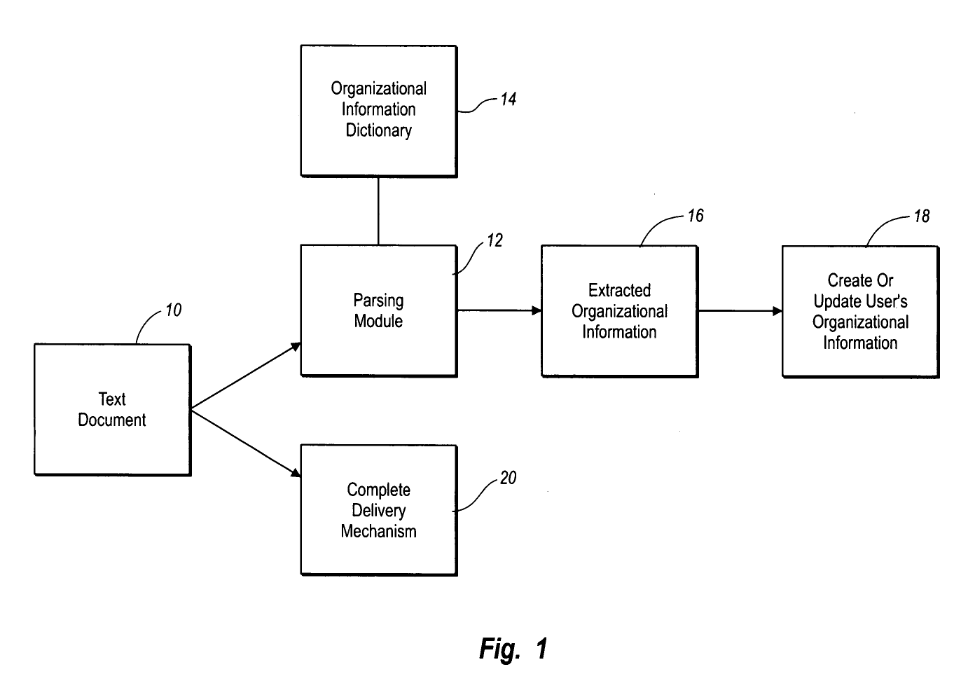

FIG. 1 illustrates an exemplary process for updating organizational information. As indicated by reference numeral 10, a text document 10 is accessed by a user. The term “access” is used broadly herein to refer to various ways that a user can obtain a text document. Thus, a text document 10 can be accessed in several ways. In one embodiment, a user can draft or create a text document using a word processing application or other user interface that allows a user to draft text documents. In another embodiment, the user can open a text document that has previously been uploaded to the user's device. In still another embodiment, the user can access a text document from the user's organizational information, for example, from an inbox in the user's email system. Other ways of accessing text documents will be apparent to those of skill in the art in view of the teachings herein. Accessing a text document also refers to creating a text document in the multi-purpose text application.

Once the text document 10 is accessed, a parsing engine 12 analyzes the text document 10. The parsing engine 12 is associated with an organizational information dictionary 14. The parsing engine 12 searches for key words or phrases that indicate that the text document 10 relates to or contains organizational information. As indicated by reference numeral 16, the parsing engine 12 extracts this organizational information.

The parsing engine 12 can also determine what type or category of organizational information is contained in the text document. Examples of types or categories of organizational information include, but are not limited to, contact information, calendar information, journal information, notes information, task information, and the like. As indicated by reference numeral 18, the user's organizational information is updated with the extracted organizational information 16. Updating the organizational information can include automatically creating or updating an organizational information entry. Alternatively, the user may be required to confirm creating or updating of organizational information. In addition, the user may be invited to provide additional or lacking organizational information to complete any organizational information entry. Advantageously, the user is not required to enter another application to recreate the organizational information entry that is already reflected in the text document 10.

In one embodiment, the text document 10 in FIG. 1 represents a text document in which a user has indicated a desired delivery mechanism or action to be taken on the text document. Such actions can include, but are not limited to, sending the text document as a text message, sending the text document as an instant message, sending an email, or creating any type of organizational information entry (e.g., contact, calendar, journal, note, task, etc.). The action can even include saving a draft of the text document. In other words, the organizational information entry can be created even though another action has been selected for the text document.

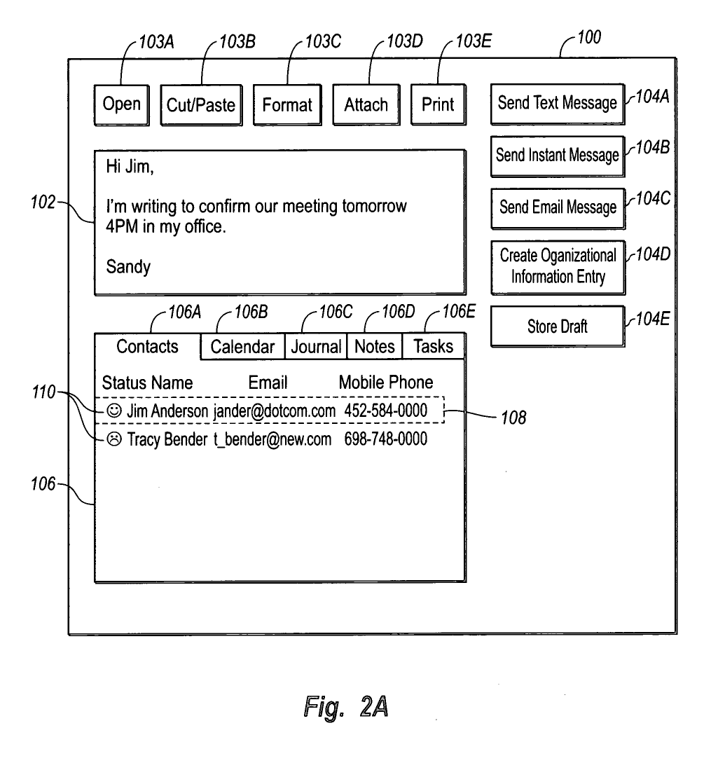

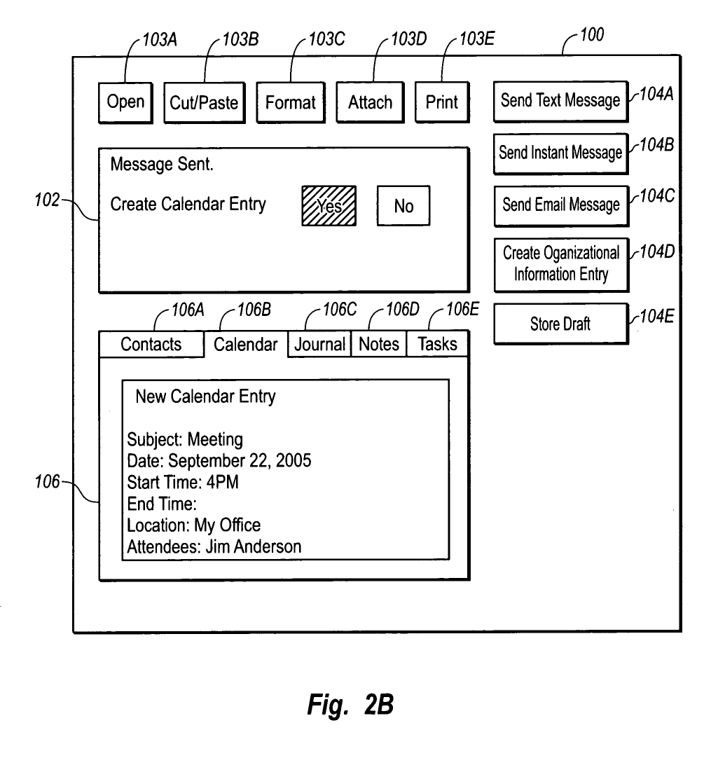

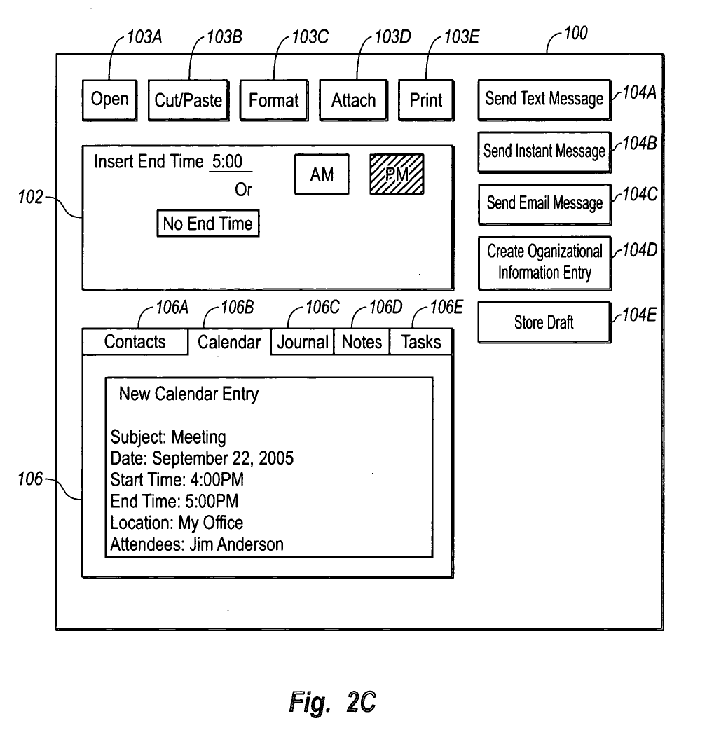

With reference to FIG. 2A, one embodiment of a multi-purpose text application with a parsing feature is illustrated. The text application 100, as will be described further below, includes a generally small, fast user interface which provides the basic functionality of most word processing applications. In the embodiment of FIG. 2A, text application 100 includes a text screen 102 that appears, in one embodiment, as a blank template. Thus, the user is able to access (open, edit, save, create, etc.) any document.

As discussed above, accessing a document refers to creating or retrieving a text document using, for example, the user interface illustrated in FIG. 2A. Thus, the text screen 102 may also have maximizing, minimizing and scrolling capabilities if the user wants to change the viewing capabilities of the text screen, such as for lengthy text documents. The text can be input, into the text screen 102 with, for example, a keyboard, a mouse, a stylus or other pointer (where the text screen is pressure sensitive), a joystick, and the like, whether directly or remotely connected. It is appreciated that the text screen 102 can be provided by a general-purpose word processing application as well.

The text application 100 can exemplarily include word processing buttons 103 that provides at least basic word processing functions such as opening existing text documents (button 103A), cut and pasting (button 103B), and formatting functions (button 103C) available in most word processing applications. The text application 100 may also include the ability to attach objects such as text and image attachments (button 103D). The text application 100 may also include printing capability (button 103E). Preferably, the text application 100 can generally be used as a generic word processor application as well as having the additional functions provided herein. It is appreciated that the text screen 102 can be used to provide dialogue windows for displaying files to be searched, attachments to be browsed, and/or formatting options.

On the text application 100 are a plurality of action selection icons or buttons 104A through 104E. During or after the user accesses a text document, the user can then select any of the action buttons 104. As used in the present invention, the term “delivery mechanism” and “action” will be used interchangeably to refer to a potential action to be performed with a text document. The terms delivery mechanism and action are broad enough to encompass delivering a text document to a local database on the user's device or to a remote location, such as a recipient device. Thus, storing a text document in a database can also be considered an action in accordance with the scope of the present invention.

As shown in FIG. 1, any number of actions may be associated with the text application 100. The following action buttons 104A through 104E are provided by way of description; but not by way of limitation: sending a text messaging 104A, sending an instant messaging 104B, sending an email 104C, creating an organizational information entry 104E and saving a draft of the text document 104E. Thus, by selecting one or more of these action buttons 104A through 104E, the user is able to activate the applications or software necessary to accomplish the desired action. It will be appreciated that other existing or future developed actions for handling a text-based document may be included in view of the teachings herein. For example, the same text document can be both sent as an email and as an instant message.

As discussed above, the user's organizational information can be updated in two ways: automatically or as selected by the user. In the embodiment in which creation or updating of organizational information occurs automatically, the user does not have to select the organizational information button 104E in order to initiate the parsing feature of the present invention. However, the user can select the organizational information button 104E, thereby actively initiating creation or updating of the user's organizational information.

As will be discussed below, the parser module 12 (FIG. 1) identifies the type of organizational information contained in text screen 102. When the user selects organizational information button 104E, the parser module can automatically determine what type of entry to make—whether a contact entry, a calendar entry, a journal entry, a note entry, a task entry, and the like. In an alternative embodiment, not shown, additional buttons may be provided to allow a user to specifically select the type of organizational information entry to be created. For example, U.S. patent application Ser. No. 11/005,348, filed Dec. 6, 2004, illustrates one embodiment in which a button is provided for each type of organizational information.

Initially, header fields on the text screen 102 (e.g., TO and FROM fields) are hidden to avoid the appearance that the text application 100 can be used only for certain types of actions (e.g., composing and sending e-mail). When an action or delivery mechanism is selected, either before, during or after the text document is drafted, the text screen 102 can be: modified to display the information necessary to carry out the selected action. In some cases, as will be described further below, it may be required for the user to produce additional information.

Text application 100 thus provides a user with the ability to switch between various types of text-based documents. The text screen 102 serves as a template for composing various types of text-based messages including, but not limited to, text messages, instant messages, and email messages. The text screen 102 is also template for entering and/or modifying a user's organizational information. Furthermore, the text screen 102 can be used to draft basic word processing documents. Thus, the user is not limited to the type of text-based document that can be accessed. In addition, the user may use the same text document for multiple purposes using the same software application.

The text application 100 may also include an organizational information screen 106 which allows a user to toggle between different types of organizational information. For example, organizational information can include a contacts screen 106A, a calendar screen 106B, a journal screen 106C, a note or memos screen 106D, and a tasks screen 106E. Exemplarily, contact screen 106A can include contact information for one or more contacts. For example, the contact screen 106A can show the name, email address or mobile phone number of each contact. Exemplarily, when a user decides to deliver a text document via text messaging, instant messaging or email, the user can select or highlight one of the contacts, as indicated by the dashed line 108 surrounding the contact named Jim Anderson. The intended contact or recipient can be selected before or after the action button 104 is selected. By selecting one of the contacts, all necessary address information (e.g., email address, mobiler phone number) is automatically provided and no other information need be provided from the user. When the contact is selected, the header fields can be automatically filled for the user.

In addition, as shown at the left of the two example contacts, an icon 110 can be used to indicate whether the contact is online or offline the same network as the user. For example, an icon indicating a face with a smile can be used to indicate that a contact is online while an icon having a face with a frown can mean that the contact is offline. Selecting the contact having an online indicator may also provide the appropriate IP and port information in order to send instant messages to the contact.

Thus, in one embodiment, present invention can be used in combination with a text application which provides multiple options relating to selecting a delivery mechanism or action for a text document. Because the user can select the particular action to be performed on the text document before, during and/or after the text document is drafted, the user is not required to commit beforehand to any particular action. As such, should the user change his or her mind regarding the particular action to be performed on the text document, or should the user be prevented in certain circumstances from taking a particular action on a text document, the user can easily select one of the other actions to perform on the text document. In addition, the user may perform more than one action on a particular text document without requiring the user to open up multiple separate applications.

Thus, the nature of the text application 100 is not only longitudinal, but lateral as well. That is, the user is able to transmit and received text documents to and from recipient devices in various ways, and is also able to maintain the user's own organizational information using text documents created and maintained on the user's device.

Furthermore, the user can postpone the selection of an action until a later date. By selecting “store draft” button 104E, the user may save the draft of the text document as a local file (or remotely on another database to which the user has access), and later retrieve the text document and perform another action 104A through 104D on the text document.

With reference now to FIGS. 2A through 2C, the parsing feature of the present invention will be described using the example of the text interface 100. In one embodiment, the user accesses a text documents by drafting one using a text-based application. As illustrated in FIG. 2A, a user is able to draft a text document and then select an action for the text document. In FIG. 2A, the user has written in the text screen 102, “Hi Jim, I'm writing to confirm our meeting tomorrow 4:00 P.M. in my office. Sandy”. In this example, the user, Sandy, intends to send this message to the recipient, Jim. The message can be sent via text messaging, instant messaging, or email, or any other messaging protocol depending on the button selected.

Before or after the user selects the desired action, or before or after the desired action is completed, a parser module 12 (FIG. 1) analyses the text in the text document. Initiation of the parser module can occur automatically through the simple act of accessing a text document. For example, one embodiment may include automatically parsing each and every text document that is accessed by the user. In another embodiment, the user can initiate parsing the text document by selecting an action button 104A through 104E.

The parser module refers to an organizational information dictionary 14 (FIG. 1) in order to identify the existence of organizational information. In addition, the organizational dictionary can be used to identify what type or category of organizational information is contained in a particular text document. In parsing the text in the text screen 102, the word “meeting” may serve as a keyword to indicate to the parser module 12 that the text relates to calendar-type organizational information. In addition, other terms such as “tomorrow”, “4:00 P.M.”, may also further indicate the existence of calendar-type organizational information. Furthermore, the parser module 12 may be able to determine the type of organizational; information based on the context in which keywords or other words are used or the text document is delivered.

When the parser module 12 determines the existence of organizational information in the text screen 102, in one embodiment, an organizational information entry can be created or updated without the user being aware. It will often be the case, however, that the user desires to confirm whether an organizational information entry is created or updated. Thus, as shown in FIG. 2B, the text screen 102 can be updated to request confirmation from the user that the user desires to create or update an organizational information entry. The shaded box in FIG. 2B indicates that the user in this example wishes to proceed with creating a calendar entry.

Once the user confirms updating of their organizational information, the parser module communicates with an organizational information application (discussed below) to retrieve the correct template. The organizational information screen 106 can be used to display the proposed template. As shown in FIG. 2A, for example, a template for a calendar entry is displayed in calendar screen 106B. (The organizational information screen 106 may also automatically open to the appropriate organizational screen for the type of organizational information identified by the parser module.) The calendar entry template exemplarily includes fields such as the subject of the appointment, the date of the appointment, the start time, the end time, the location of the appointment, the attendees, and the like. The parser module includes logic to insert information into as many of the fields required for each organizational information entry as possible.

Based on the example of FIG. 2A, calendar screen 106B the subject field reads “Meeting” based on the keyword “meeting” in the text document. The date field indicates a date, if ascertainable, that is identified by the parser module. In this example, the user has simply stated “tomorrow.” The parser module is able to identify the date based on referencing on an internal calendar that may be maintained on, for example, the operating system of the user's device. (In this hypothetical example, the date was selected arbitrarily in order to show that the parser module is able to ascertain the date and insert it into the correct field.) The start time field reads “4:00 P.M.” based on the key word “4:00 P.M.” that was located in the text document. Furthermore, the location field indicates “My Office” based on the determination of the parser module that the term “my office” in the text document refers to the user's office. Finally, the attendees field includes the recipient's name which can be extracted by the parser module. The attendees field may further include any other recipients to which the user may send the text document, for example, if the user copies one or more recipients when sending the message.

In some cases, some fields will remain blank due to lack of information in the text document. In the example above, the user did not indicate an end time for the meeting. As shown in FIG. 2C, the text screen 102 may be used to request that a user provide any unascertainable information. The shaded box in the text screen 102 indicates that the user has indicated that the meeting end at 5:00 PM. It will be appreciated that the user is able to create an organizational information entry without providing all of the necessary information. For example, FIG. 2C provides an option in which the user does not select an end time for the appointment.

After as much information as possible is obtained by the parser module and, optionally, from the user, the user can verify the creation or updating of an organizational information entry. In addition, the text screen 102 can indicate any steps that occurred with respect to the selected delivery mechanism or action. For example, as shown in FIG. 2B, the text screen 102 reflects that the message was delivered.

The parser module also updates an organizational information entry. The parser module contains logic which can compare whether an existing organizational information exists on the database associated with the organizational information application 208D. The parser module can then provide the user with the proposed updated organizational information entry and the user can confirm whether or not to update the entry. Alternatively, the parser module may automatically update the organizational information entry without requiring user confirmation.

The parser module is thus able to identify text segments, words, or phrases that indicate existence and types of organizational information. For calendar information, the parser module can be configured to search for text that relates to the subject, date, starting time, ending time, location, attendees, and the like, for a calendar entry. With respect to contact information, the parser module may be able to determine text relating to names of contacts, email addresses, mobile phone numbers, addresses, fax numbers, business names, and the like, for a contact entry. With regard to journal information, the parser module may search for text that relates to subjects of events, dates, start times, end times, names, places, and the like, for a journal entry. With respect to task information, the parser module may search for text reflective of a list to create a task entry. In addition, the parser may search for information pertaining to a due date, a start date, an end date, a date that the task is completed, and the like, for creating a task entry.

Finally, with respect to note or memo information, in one embodiment, the parser module may be configured to create by default a note entry if the parser module is unable to identify any other organizational information. Thus, all basic text documents that do not fall under any other type of organizational information may be stored and listed or searchable in the notes screen 106D. This may be beneficial because notes are generally simple text, documents and can easily be converted to a word processing document or deleted altogether if the user decides that there is no reason to keep the created note entry.

The parser module of the present invention is intelligent enough to be able to determine the context in which the text document is accessed and/or used. For example, if the user selects as an action to send a text message, instant message or email message, the parser module may not, in certain circumstances, create or update the user's organizational information. For example, suppose a user sends an instant message to their spouse which reads “remember to pick up kids at 5:00 P.M. tomorrow”. If the user sends this as an instant message, the parser module determines that the particular task indicated in this message is not intended for the user, but rather for the spouse to whom the instance message was sent. As such, it may not be necessary to create an organizational information entry for the user. However, the parser module could be configured to provide the user the option to create or update organizational information, even in this situation.

The intelligence of the parser module is also illustrated in the following example. Suppose the user wrote in the text screen 102, “Remember to pick up kids at 5:00 p.m.” and then selected button 104D to create an organizational information entry. The parser module would then determine that the task identified in the text document was intended for the user. This example also illustrates that it is possible for more than one type of organizational information to be determined by the parser module. For example, the parser module could identify that potentially a calendar entry and a task entry could be created from the above scenario. The parser module could then provide the user to create one or both of the organizational information entries. It will be appreciated that the user is saved the time from creating two separate organizational information entries by simply confirming that they want to create both.

As discussed above, accessing a text document-also includes analyzing incoming text documents. For example, the parser module 12 could analyze incoming email messages received by the user's device. It will be appreciated that a user interface similar to that! shown in FIGS. 2A through 2C may also be used in this embodiment. That is, when a user accesses an incoming text document, such as when the user access the user's inbox, the parser module 12 can detect and parse the accessed message in much the same manner that the parser module 12 handles text documents drafted by the user. The user interface 100 can be configured to carry the user through the steps necessary to create or update an organizational information entry. However, the present invention is not limited to the user interface 100 described in FIGS. 2A through 2C and may be implemented in a user interface having different features as understood by those of skill in the art.

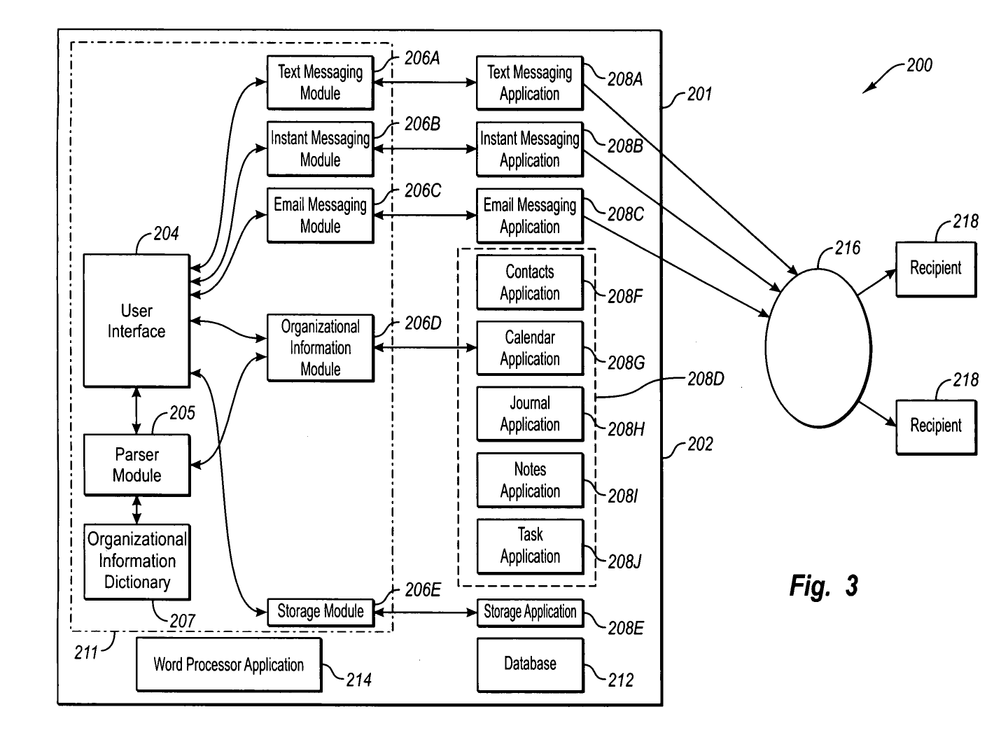

Turning now to FIG. 3, an exemplary system and software configuration 200 is provided by way of explanation and not limitation. System 200 includes a user device 201. User device 201 may include, but is not limited to, a personal computer, a hand-held computer, a laptop computer, a mobile phone, an organizational information assistant, and the like. Device 201 can include a special-purpose text application indicated by reference numeral 202.

Text application 202 includes a user interface 204. User interface 204 provides the user interface 100 features shown in FIG. 1 including the text screen 102 and word processing buttons 103. As discussed above, user interface 204 is a generic text application which allows a user to access text documents. User interface 204 communicates with a parser module 205. The parser module 205, in turn, communicates with an organizational information dictionary 207.

User interface 204 communicates with a plurality of action modules 206A through 206E. Exemplarily, the action modules include a text messaging module 206A, an instant messaging module 206B, an email module 206C, an organizational information module 206D, and a storage module 206E. Each of modules 206A through 206E initiates the required functions to complete the action associated with the module. The user is thus able to select, one or more of the action buttons 104 (FIG. 1) to initiate action modules 206A through: 206E to perform a particular action on the text document accessed through the user interface 204. The user interface 204 also communicates with organizational information module 206D to provide the organizational information screen 106 (FIG. 1). As shown in FIG. 3, the parser module 205 also communicates with organizational information module 206D.

As further shown in FIG. 3, the text application 202 includes applications 208A through 208E that communicate with each of the action modules 206A through 206E. Exemplarily, action applications 208A through 208E include a text messaging application 208A, an instant messaging application 208B, an email application 208C, an organizational information application 208D, and a storage application 208E. It will be appreciated that any number of existing or future-developed action modules 206 and corresponding applications 208 may be implemented as necessary in view of the teachings of the present invention.

In some embodiments, one or more of the applications 208A through 208E may be implemented using existing applications in the art. For example, the dash line 208D represents that one or more of the applications, may be embodied in one software application. For example, the organizational information application 208D may include applications that can be sub-divided into a contacts application 208F, a calendar application 208G, a journal application 208H, a notes application 208I, and a task application 208J. In another embodiment, organizational information application 208D may be configured as distinct applications as discussed in further detail in U.S. patent application Ser. No. 11/005,348, filed Dec. 6, 2004, herein incorporated by reference. Other variations for grouping applications 208A through 208E are possible.

It is also possible for the text application 202 to be bifurcated so that a portion indicated by reference numeral 211 is located on user device 201 while the remaining components of text application 202 are located elsewhere, e.g., a remote server with which the guser device 201 communicates. For example, to minimize the footprint of text application 202 on a user's mobile phone, portion 211 could be located on the user's mobile phone and communicate with a server to provide the additional functionality of the text application 202.

As shown in FIG. 3, each of applications 208A through 208E can access a database 212. While the database 212 is shown as a single entity, it will be appreciated that the database 212 may include one or more drives, remote or local, to which the user device 201 has access. In addition, it is possible for each application 208A through 208E to access different databases. However, a single database 212 is illustrated simply to show that the applications 208A through 208E are able to access some type of database.

The database 212 can store information related to each application 208A through 208E. For example, in the case of text message application 208A, the database 212 can track mobile phone numbers. In the case of instant messaging application, the database 212 can store IP addresses and ports for various recipients. The tracking database 212 can also be used to track the online status of one or more recipients to which the user desires to send an instant message, buddy lists, and the like. In the case of email application 208C, the database 212 can store email addresses, group lists, approved email addresses, unapproved email addresses, sand the like. In the case of organizational information application 208D, the database 212 can store organizational information relating to contact information, calendar information, journals, notes, and tasks. Furthermore, in the situation where a user desires to save a draft of a text document, storage module 208E communicates with database 212 to; store a draft.

In some embodiments, the user interface 204 can access an existing word processing application 214 residing on the user device 201. This can help to minimize the amount of code required to develop the user interface 204. It will be appreciated, however, that text application 202 does not have to access an existing word processing application residing on the user's device, but could have all of the necessary word processing code already programmed into it.

Thus, FIG. 3 also illustrates an exemplary network configuration. The user device 201 communicates with a network 216, which can include one or more servers. The network 216 also communicates with one or more recipient devices 218. Similar to the user device, the recipient devices 218 can include, but are not limited to, a personal computer, a hand-held computer, a laptop computer, a mobile phone, an organizational information assistant, and the like.

The parsing module can thus be initiated when the user accesses any text document whether by drafting or reading a text document. Exemplarily, when the user drafts a text document using, for example, the multi-purpose user interface of FIGS. 2A through 2C, the user interface 204, initiates the parser module 205. The parser module 205 (communicating with the organizational information dictionary 207) analyzes the text document to identify organizational information. Upon recognition of one or more types of organizational information, the parser module 205 communicates with the organizational information module 206D to retrieve the appropriate organizational information template. The parser module 205 then proceeds to create or update the user's organizational information accordingly.

The parsing module can also be initiated by other means of accessing” a text document including receiving or uploading a text document, using, for example, user interface 204. The user can access any type of text document such as, but not limited to, a word processing document, an email message, an instant message, and the like. When the user accesses the text document, the user interface 204 initiates the parser module 205 which can then follows similar steps described above for creating or updating the user's organizational information. The parser module 205 can be configured to analyze any text document accessed by the user or can be configured to analyze only incoming text documents such as text messages, email messages, or instant messages. In some cases, messages such as text, email or instant, are more likely to contain organizational information.

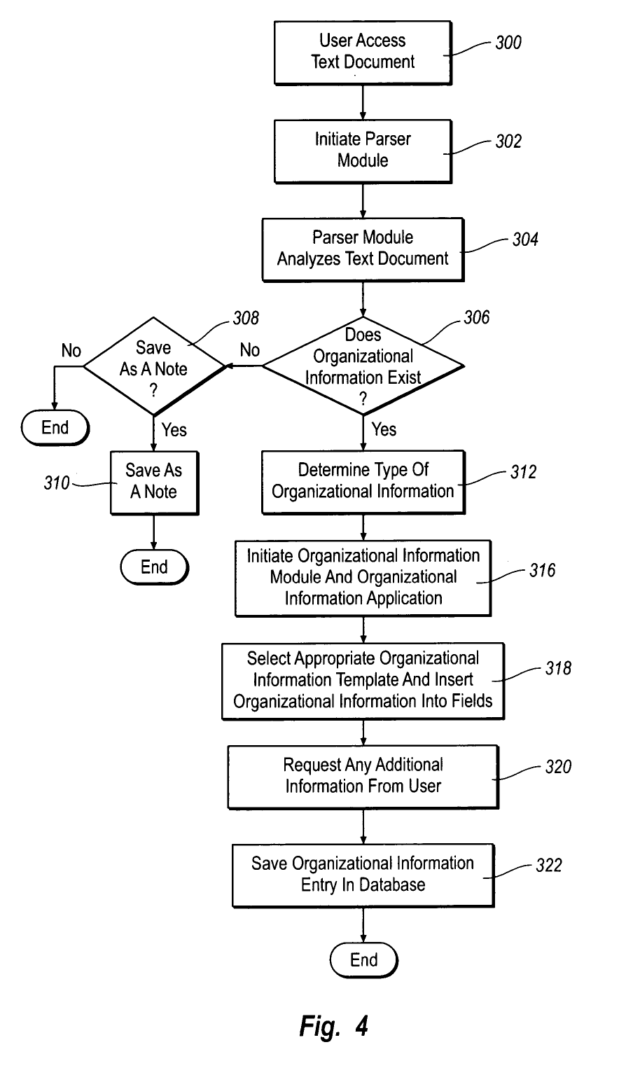

FIG. 4 illustrates an exemplary method for implementing embodiments of the present invention. At step 300, the user accesses a text document, either using the multi-purpose text application or a general purpose text application. At step 302, the parser module is initiated. As described above, the parser module can be initiated by the act of accessing a text document. In other embodiment, the parser modules is initiated by selecting a delivery mechanism (e.g., selecting action buttons 104A through 104E, FIG. 2). In still another embodiment, the parser module can be initiated by accessing incoming messages.

At step 304, the parser module 205 analyzes the text document using the organizational information dictionary 207 to identify key words and phrases which indicate a potential organizational information entry. At step 306, the parser module determines whether organizational information is present in the text document. If there is no-organizational information that the parser module can ascertain, at step 308, the process provides the user the option to save the text document as a note. If the user decides to save the note, at step 310, the note is saved and the process ends. If the user selects not to save the note, the process ends.

If the parser module detects organizational information, at step 312, the parser module determines the type of organizational information—contact, calendar, journal, note, task, etc. At step 314, the parser module initiates the organizational information module 206D to communicate with the organizational information application 208D. At step 318, the parser module selects the appropriate template and inserts the ascertainable information into the template. At step 320, the parser module provides the user the opportunity to supply any additional or lacking information. At step 322, the organizational information entry is saved in a database associated with the organizational information application 208D and the process ends.

It will be appreciated that the steps of the foregoing method may vary depending on design parameters. For example, the user may select the delivery mechanism before, during, or after accessing the text document. In addition, the default to save the text document as a note if the parser module does not detect organizational information may be eliminated in some embodiments. In another embodiment, selecting the organizational information button 104E could provide the user with the option to specify the type of organizational information entry to create. In this embodiment, the process could skip steps 306 and 312 since the type of organizational information is already specified. In still other embodiments, the user may not be involved in any aspect of creating or updating organizational information except for the act of drafting a text document. Other configurations are also possible in view of the teachings herein.

The embodiments of the present invention may comprise a special purpose or general-purpose computer including various computer hardware. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation; such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which the invention may be implemented. Although not required, the invention has been described in the general context of computer-executable instructions, such as program modules, being executed by computers in network environments. Generally, program modules include routines, programs, objects, components, data structures, etc. that perform particular actions or implement particular abstract data types. Computer-executable instructions, associated data structures, and program modules represent examples of the program code means for executing steps of the methods disclosed herein. The particular sequence of such executable instructions or associated data structures represents, examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where actions are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for updating organizational information, the system comprising:
a user interface configured to allow a user to access a text document;
a parser module configured to initiate parsing of the text document when the user accesses the text document, wherein the parser module identifies organizational information in the text document; and
an organizational information module communicating with an organizational information application, the user interface and the parser module communicating with the organizational information module to update the organization information application with the organizational information identified in the text document.

2. The system as recited in claim 1, further comprising an organizational information dictionary in communication with the parser module, the organizational information dictionary configured to assist the parser module in identifying and classifying organizational information located in the text document.

3. The system as recited in claim 1, wherein the user interface comprises an organizational information screen including information for one or more types of organizational information.

4. The system as recited in claim 1, further comprising one or more delivery mechanism modules configured to perform one or more actions on the text document.

5. The system as recited in claim 4, wherein the actions include one or more of:
send the text document as an email;
send the text document as an instant message;
send the text document as a text message; and
store the text document as a draft document.

6. The system as recited in claim 1, wherein the user interface confirms the organizational information identified in the text document.

7. The system as recited in claim 1, wherein the user interface automatically enters the organizational information in the organizational information application.

8. The system as recited in claim 1, wherein the user interface prompts the user for additional information not included in the identified organizational information.

9. A method for updating organizational information when accessing a text document, the method comprising:
accessing a text document using a user interface;
parsing the text document to identify organizational information in the text document using an organizational information dictionary;
classifying the identified organizational information into one or more types of organizational information;
determining whether the identified organizational information is new; and
updating a user's organizational information with the identified organizational information for each of the one or more types or organizational information included in the text document.

10. The method as recited in claim 9, wherein accessing a text document further comprises at least one of:
identifying the text document drafted by the user;
creating the text document;
drafting the text document;
opening the text document;
receiving the text document from another user;
retrieving one or more messages from an inbox of the user; and
opening a text document that was downloaded to a device of the user.

11. The method as recited in claim 9, wherein parsing the text document to identify organizational information and classifying the organizational information further comprises communicating with the organizational information dictionary.

12. The method as recited in claim 9, wherein determining whether the organizational information is new further comprises at least one of:
accessing an organizational information application which maintains the user's organizational information and comparing the identified organization information from the text document with existing organizational information stored in the user's organizational information;
retrieving an organizational information entry which contains at least some of the same organizational information identified by the parser module; and
retrieving a blank organizational information template in at least one of the types of organizational information identified by the parser module.

13. The method as recited in claim 12, wherein updating a user's organizational information with the identified organizational information further comprises at least one of:
inserting new organizational information into an organizational information entry;
inserting the identified organizational information into the organizational information entry;
automatically updating the user's organizational information without the user's involvement; and
requesting confirmation from the user to update the user's organizational information.

14. The method as recited in claim 9, further comprising performing one or more delivery mechanisms on the text document, the one or more delivery mechanisms being selected by the user through the user interface.

15. A method for updating a user's organizational information database with organizational information included in a text document, the method comprising:
initiating a parser module to parse a text document displayed in a user interface;
analyzing the text document with an organizational information dictionary to identify organizational information in the text document;
determining at least one type for the identified organizational information;
selecting an template that corresponds to the at least one type;
inserting the identified organizational information into the selected template; and
updating the user's organizational information database with the organizational information inserted in the selected template.

16. A method as recited in claim 15, wherein initiating a parser module to parse a text document displayed in a user interface further comprises at least one of:
initiating the parser module in response to user input; and
automatically initiating the parser module upon accessing the text document.

17. A method as recited in claim 16, wherein accessing the text document comprises one or more of:
creating the text document;
receiving the text document from another user;
downloading the text document from an application;
opening the text document; and
selecting a delivery mechanism for the text document.

18. A method as recited in claim 15, wherein inserting the identified organizational information into the selected template further comprises at least one of:
automatically saving the selected template to the user's organization information database;
prompting the user to confirm the identified organizational information inserted in the selected template;
requesting organizational information not found by the parser module in the text document from the user;
determining if the identified organizational information is already included in the user's organizational information database; and
selecting another template for other types or organizational information identified by the parser module.

19. A method as recited in claim 15, further comprising prompting the user to save at least a portion of the text document as a note in the user's organizational information database if organizational information is not identified in the text document.

20. A method as recited in claim 15, further comprising automatically saving at least a portion of the text document as a note in the user's organizational information database if organizational information is not identified in the text document.
